(19) United States
(12) Patent Application Publication
(10) Pub. No.: US 2008/0109288 A1
(43) Pub. Date: May 8, 2008

(54) Systems and methods for post-trade transaction cost estimation of transaction costs

(75) Inventors: Milan Borkovec, Boston, MA (US); Ian Domowitz, New York, NY (US); Hans G. Heidle, Quincy, MA (US)

Correspondence Address: ROTHWELL, FIGG, ERNST & MANBECK, P.C., 1425 K STREET, N.W., SUITE 800, WASHINGTON, DC, 20005, US

(73) Assignee: ITG Software Solutions, Inc., Culver City, CA (US)

(21) Appl. No.: 11/976,433

(22) Filed: Oct. 24, 2007

Related U.S. Application Data
(60) Provisional application No. 60/853,765, filed on Oct. 24, 2006.

(51) Int. Cl. G06Q 10/00; G06F 17/11

(52) U.S. Cl. 705/7

(57) ABSTRACT

A system for post-trade estimation of transaction costs. The system may include transaction cost estimation facilities configured to receive order data relating to a plurality of trade orders, receive execution data relating to a plurality of trades corresponding to the plurality of trade orders, to calculate post trade estimated transaction costs for each of the plurality of trade orders based upon a pre-trade cost estimation model, the execution data, and actual market conditions at an execution time of the plurality of trades, and to store the post trade estimated transaction costs. The system may also include data storage facilities coupled with the transaction cost estimation facilities and configured to store at least the post trade estimated transaction costs in an accessible format.

### REFERENCE TO RELATED APPLICATION

Pursuant to 35 U.S.C. § 119(e), this application claims priority to U.S. Provisional Patent Application Ser. No. 60/853,765 filed on Oct. 24, 2006, the entire contents of which is incorporated herein by reference.

### BACKGROUND OF THE INVENTION

1. Field of the Invention

This invention relates generally to systems and methods for estimating transaction costs for institutional trading. Particularly, this invention relates to systems and methods for post trade estimation of transaction costs taking into account realized market conditions.

2. Background of the Related Art

In the financial trading industry, understanding the components behind transaction costs has become an integral part of the investment process. In order to increase investment returns and boost the ranking of a firm or fund, traders need to examiner closely their transaction costs. Over recent years, “the Market” has seen an unusual increase in utilization of pre-trade transaction cost models, which identify trading strategies that weigh expected trading costs against execution risk as modeled by stock price volatility. Such models are typically based on the work of Bertsimas and Lo (1998), Almgren and Chriss (2000), and Huberman and Stanzl (2005), in which the best execution may be defined as the trading strategy that provides the minimum execution costs for trading over a fixed period of time while taking into account the volatility of stock prices associated with different strategies.

Domowitz, Glen, and Madhavan (2002) identified transaction costs as a key element in evaluating portfolio performance. Large enough execution costs substantially reduce or even eliminate the notional return. Monitoring and minimizing these costs has become the industry norm.

Pre-trade cost models typically measure the institutional average price impact costs. A crucial assumption in these models is market neutrality. Consequently, the estimated pre-trade costs are entirely based on one's own trading strategy, and the associated price impact.

Current pre-trade models do not account for or reliably account for unknown conditions, such as market effects due to other market participants, short-term serial correlations in price movements, news events/announcements, and the underlying investor sentiment in the market. Evaluating these conditions can render useful trader information.

Post-trade benchmarks exist which can estimate transaction costs based on actual data, which could include such market effects. However, known benchmarks are merely simple regressions of costs versus market factors and do not account for one's own trading or trading strategies.

Thus, there is a need for new and improved systems and methods for estimating transaction costs.

### SUMMARY OF THE INVENTION

According to embodiments of the present invention, systems and methods are provided for post-trade estimation of transaction costs that utilize a post-trade transaction cost model, which incorporates market factors, such as market returns and trade imbalances, into an estimation of transaction costs. Further, the inventive model may be also applied to known pre-trade estimation systems and methods. Further, the estimated transaction costs may then be decomposed into (1) transaction costs due to one's own trading strategy and (2) transaction costs due to general market effects.

According to an embodiment of the present invention, a system for post-trade estimation of transaction costs is provided. The system may include transaction cost estimation facilities configured to receive order data relating to a plurality of trade orders, receive execution data relating to a plurality of trades corresponding to the plurality of trade orders, to calculate post trade estimated transaction costs for each of the plurality of trade orders based upon a pre-trade cost estimation model, the execution data, and actual market conditions at an execution time of the plurality of trades, and to store the post trade estimated transaction costs. The system may also include data storage facilities coupled with the transaction cost estimation facilities and configured to store at least the post trade estimated transaction costs in an accessible format.

According to an embodiment of the present invention, a method is provided for estimating transaction costs. The method may include a step of, for a plurality of proposed trade orders associated with a trading entity, calculating estimated pre-trade transaction costs for each of the proposed trade orders based on a selected trade strategy and on historical market data. The method further may include a step of receiving execution data relating to a plurality of executed trades corresponding to the proposed trade orders. The method further may include a step of calculating estimated post-trade transaction costs for each executed trade based upon corresponding cost of estimated pre-trade transaction costs and on corresponding execution data of execution data. The method further may include a step of aggregating estimated post-trade transaction costs to generate an aggregated estimated post-trade transaction cost for the trading entity.

According to an embodiment of the present invention, a method is provided for post-trade estimation of transaction costs. The method may include steps of dividing a trading time into a plurality of bins, using a pre-trade model to determine expected transaction costs during at least one of the bins, receiving execution data for the at least one bin, performing panel data regression over the execution data to determine a coefficient, and estimating transaction costs using both the expected transaction costs and the coefficient.

According to another embodiment of the present invention, a system is provided for post-trade estimation of transaction costs. The system may include a trade cost estimate configured to divide a trading time into a plurality of bins, using a pre-trade model to determine expected transaction costs during at least one of the bins, to receive execution data for the at least one bin, to perform panel data regression over the execution data to determine a coefficient, and to estimate transaction costs using both the expected transaction costs and the coefficient. Transaction costs may be displayed in a graphical user interface (GUI) on a trading desktop or the like.

According to an embodiment of the present invention, a computer program product is provided for post-trade estimation of transaction costs. The program may be stored on a computer readable medium and include executable instruction for performing operations to divide a trading time into a plurality of bins, using a pre-trade model to determine expected transaction costs during at least one of the bins, in response to receiving execution data for the at least one bin, to perform panel data regression over the execution data to determine a coefficient, and to estimate transaction costs using both the expected transaction costs and the coefficient.

According to an embodiment of the present invention, a system is provided for market simulation utilizing post-trade estimation of transaction costs. The system may included transaction cost estimation facilities configured to receive order data relating to a plurality of trade orders, receive simulated execution data relating to a plurality of simulated trades corresponding to the plurality of trade orders, to calculate post trade estimated transaction costs for each of the plurality of trade orders based upon a pre-trade cost estimation model, the execution data, and simulated market conditions at an execution time of the plurality of trades, and to store the post trade estimated transaction costs. A market simulator may be provided for simulating the market conditions utilizing historical trade data. Data storage facilities may be coupled with the transaction cost estimation facilities and configured to store at least the post trade estimated transaction costs in an accessible format.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

FIG. 1 is a flowchart of a method for estimating transaction costs according to an embodiment of the present invention;

FIG. 2 is a block diagram of a system for estimating transaction costs according to an embodiment of the present invention.

FIG. 3 is a table reporting results for different strategies;

FIG. 4 is a table of liquidity group thresholds;

FIG. 5 is a table of descriptive statistics for listed stocks;

FIG. 6 is a table of descriptive statistics for over-the-counter (OTC) stocks;

FIG. 7 is a chart of equally-weighted average realized transaction costs by liquidity group;

FIG. 8 is a chart of equally-weighted average realized transaction costs by order size for Listed stocks;

FIG. 9 is a chart of equally-weighted average realized transaction costs by order size for OTC stocks;

FIG. 10 is a chart of average adjusted R²'s for different liquidity groups for Listed and OTC stocks;

FIG. 11 is a chart of estimates of coefficient gamma for different order size buckets for liquidity group 10 of listed stocks;

FIG. 12 is a chart of estimates of coefficient gamma for different order size buckets for liquidity group 5 of listed stocks;

FIG. 13 is a chart of average realized costs vs. pre-trade and post-trade ITG® ACE® estimates for listed stocks;

FIG. 14 is a chart of average realized costs vs. pre-trade and post-trade ITG® ACE® estimates for OTC stocks;

FIG. 15 is a chart of a comparison of cost prediction errors for pre-trade and post-trade ITG® ACE® estimates for listed stocks;

FIG. 16 is a chart of a comparison of cost prediction errors for pre-trade and post-trade ITG® ACE® estimates for OTC stocks;

FIG. 17 is a chart of average realized costs for opportunistic vs. non-opportunistic orders for listed stocks;

FIG. 18 is a chart of average realized costs for opportunistic vs. non-opportunistic orders for OTC stocks; and

FIG. 19 is a screen shot of an exemplary interface

### DETAILED DESCRIPTION OF THE PREFERRED EMBODIMENTS

According to the present invention, systems and methods for estimating transaction costs utilize a novel post-trade transaction cost model that is based on a pre-trade cost model and which incorporates general market factors, such as market returns and trade imbalances, and actual trade data, into an estimation of transaction costs. Further, the inventive model may be also applied to known pre-trade estimation systems and methods, such as, Investment Technology Group's Agency Cost Estimator (ITG® ACE®) (embodiments of which are described in U.S. patent application Ser. No. 10/166,719, filed on Jun. 12, 2002, the entire contents of which are hereby incorporated by reference). By incorporating market factors, it is possible to estimate transaction costs more accurately. Further, the estimated transaction costs may then be decomposed into (1) transaction costs due to one's own trading strategy and (2) transaction costs due to general market effects.

In one embodiment of the present invention, potential endogeneity problems are addressed through an instrumental variable approach rather than using the stock-specific momentum proxy. This instrumental variable approach yields reasonable predictions for the stock-specific momentum proxy for most, but not all, cases. For the cases in which the instrumental variable approach does not yield a reasonable predictor heuristic rules can be applied. Moreover, for very small order sizes, endogeneity is not generally an issue, and thus the use of the stock-specific momentum proxy yields reasonable predictions.

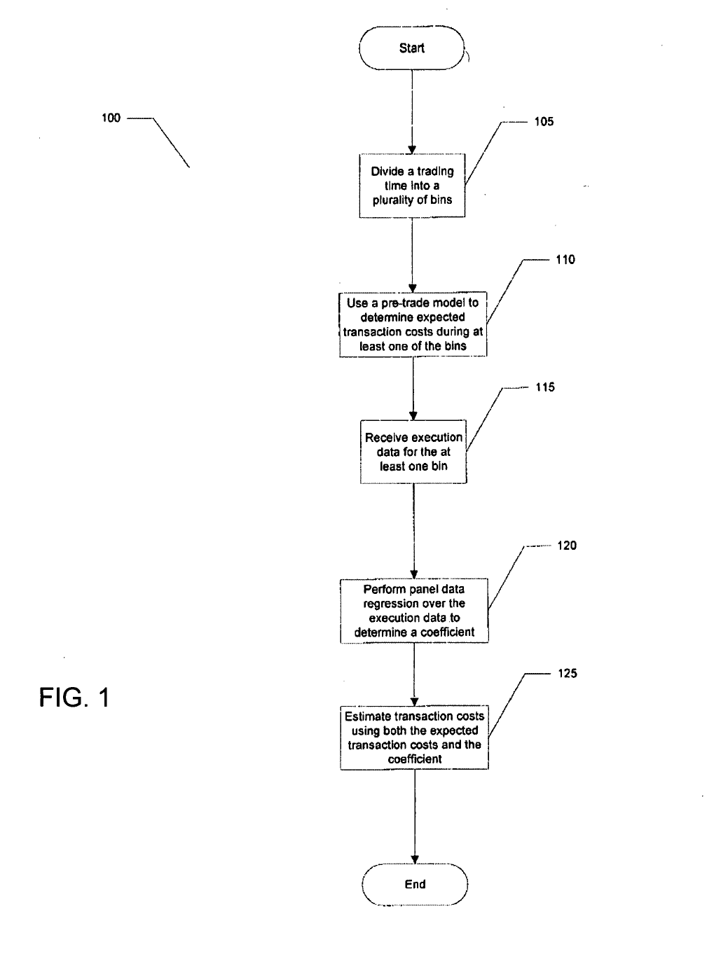

FIG. 1 is a flowchart of a method for estimating transaction costs according to an embodiment of the present invention. Method 100 may be applied to either a pre-trade strategy or a realized strategy, and further may be applied as part of a simulation method. At step 105, a desired trading horizon, or time, can be divided into a plurality of bins. At step 110, an appropriate pre-trade model, such as ITG® ACE® and those described in further detail below, is used to determine expected transaction costs for proposed trades during at least one of the bins. At step 115, actual execution data for the bin or bins is received. For example, execution data can be obtained from a sell side brokerage or from an investment firm. At step 120, a regression is performed on the actual execution data received in step 115. The results of the regression are coefficients used in the calculation of step 25. At step 125, transaction costs for the proposed trades are calculated based upon the expected transaction costs and on the execution data for the actual trades. Market factors are incorporated into step 125 in order to improve accuracy. Further, the expected transaction costs can be weighted, if necessary. The results of transaction costs for a plurality of traders, step 125, can be stored and/or displayed. Further details of various embodiments of the inventive methods are described below.

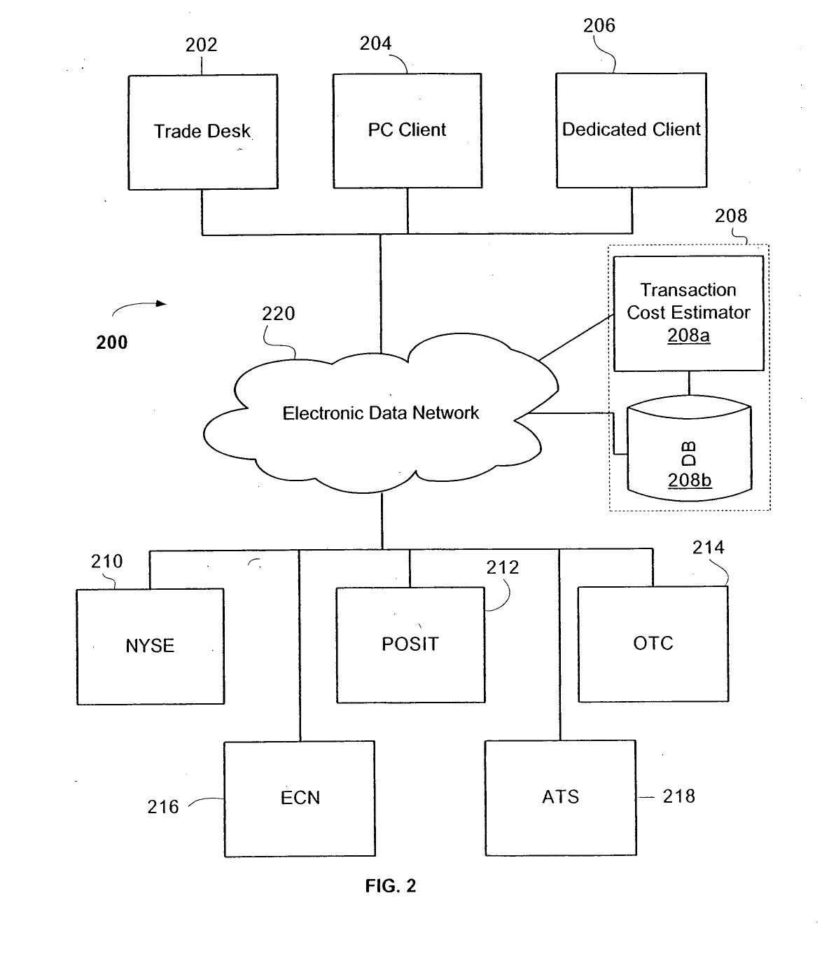

FIG. 2 is a block diagram of a trading system that includes features for estimating transaction costs according to an embodiment of the present invention. System 200 can include a number of trading devices (202-206) coupled with an electronic data network 220 (e.g., Internet, intranet, LAN, WAN, etc.), which can access a number of trading forums (210-218) in order to view market data, place trades, manage portfolios, etc. Further, system 200 can include processing facilities for transaction cost estimation (208) according to the present invention.

Trading devices may include well know trade desks 202, PC clients 204 executing financial trading software (e.g., OMS, EMS, etc.), or dedicated trade clients 206. Such trading devices can include a graphical user display (GUI) for displaying market data, portfolio information, trade blotters, analytical information, etc. Trade devices can communicate with trade forums by well known techniques, such as via messaging (e.g., FIX protocol) and can send and receive information thereto. Such trading devices are readily available and well known, and shall not be described in further detail in this paper. Trade routers and other intermediate devices are not shown.

Trade forums may include the New York Stock Exchange 210, ITG's POSIT® 212, the over-the-counter market 214, ECN's 216, and other ATS's 218.

A transaction cost estimation system 208 can be coupled to the electronic data network 220 and may include processing facilities for transaction cost estimation 208a and data storage facilities 208b for storing cost estimation models, transaction data, historical trade data, etc. The transaction cost estimation system 208 may be configured to communicate with other trade systems, to receive and store market data, and to perform processing consistent with the methodology described herein. Of course, the skilled artisan will understand that the system 208 need not be a stand alone device and one or more features of the system may be incorporate in a client front end or may be implemented in a distributed architecture.

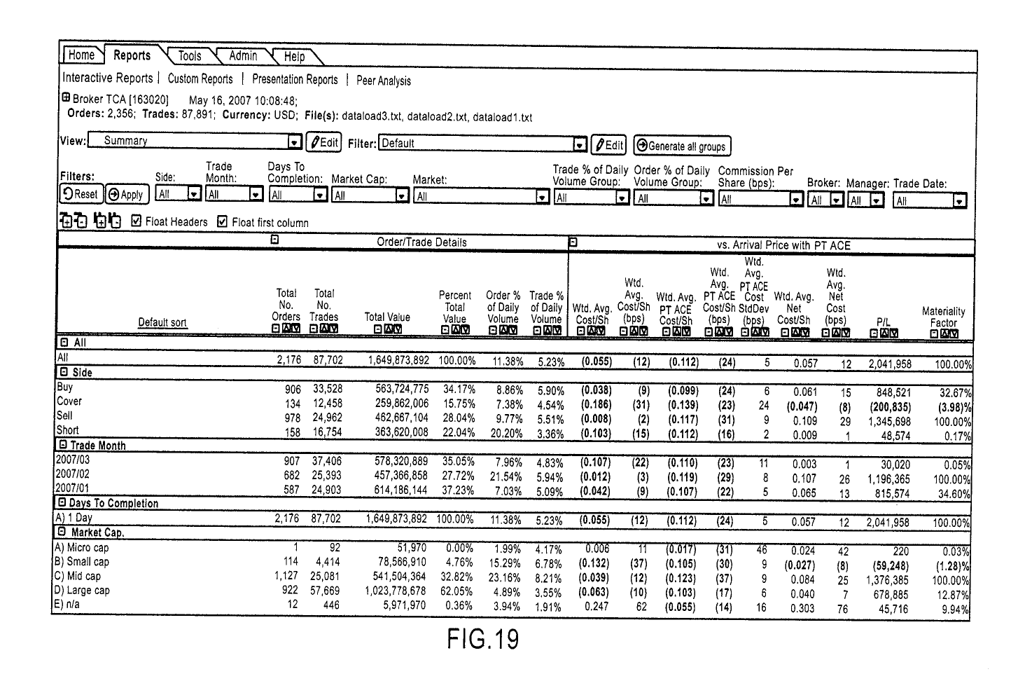

A GUI interface may be provided for which trade cost estimation may be requested for a plurality of trades. For example, FIG. 19 is a screen shot of such a GUI. As shown, a user may select a number of different Views, Filters, and Groups. Filters can include the Side, Period (e.g., Months), Days to Completion, Market Capitalization, Market, Trade % of Daily Volume Group, Order % of Daily Volume Group, Commission per share, Broker, Manager, and Trade Data. Aggregate information can be calculated (in advance or on-the-fly) and displayed based on the Filters selected. As shown, a first section of the GUI labeled Order/Trade Details, displays aggregate trade data for the selected trade entity—in this case, the entire firm. The second half of the GUI labeled vs. Arrival Price with P-T ACE, displays industry average costs along side of post trade estimated costs (PT ACE)., along side other information.

One skilled in the art will recognize that the post trade estimated costs can be a useful benchmark for a trade entity's performance, whether a brokerage or trading firm, a manager or an individual trader. Further, although the data displayed in FIG. 19 is limited to a number of different Filters, one skilled in the art should understand that the system and methods of the present invention could be applied to benchmark order data segmented in other useful groups, such as Sector.

While FIG. 2 is a simplified block diagram of a system capable of performing the present invention, it should be understood that the shown configuration is only one of many that could be used, and in no way should the present invention be limited to the system shown in FIG. 2.

Further details regarding various features of the systems and methods for post-trade transaction cost estimation according to the present invention are set forth below.

Post-Trade Cost Estimation Model

This section outlines the general framework of exemplary pre-trade models and features of the invention for providing enhanced post-trade transaction cost estimates.

The systems and methods of the present invention utilize a post-trade cost estimation model. A framework is provided including necessary assumptions underlying existing pre-trade transaction cost models (e.g., ITG® ACE®), and this class of pre-trade models is mapped to a post-trade model setting that provides useful, nonobvious enhancements to trading cost estimations, according to embodiments of the present invention.

An exemplary theoretical pre-trade transaction cost model may divide each trading day into N periods of equal duration (bins). For example, for the U.S. financial trading market, the trading day can be broken into thirteen 30-minutes bins. A trading horizon can consist of several days with arbitrary starting and ending bins on the first and last day, respectively. Thus, a trade order for any given security may be defined by:

the trading horizon T (in days) with starting bins on the first day and ending bin e on the last day,

the side δ, where δ=1 (−1) for BUY (SELL),

the size S, and

the trading strategy (nᵢⱼ)_{i=1, . . . , T,j=1, . . . , N}, the sequence of share quantities per bin for a given T,

where nᵢⱼ is the number of shares of the security traded in bin j on day i and N is the number of bins on a given day. It may be assumed that trading of all share quantities is completed within their respective bins.

The average transaction costs (per share) of a trade order with the above characteristics may be defined as the signed difference between the price p_{1,s-1} of the security at order placement time (i.e. the end of bin s−1 of day 1) and the volume-weighted average execution price. Specifically,

$$\begin{matrix}Pre\_Cost ( S , {( {n}_{ij} )}_{i = 1 , … , T ; j = 1 , … , N} ) = δ \cdot ( [ {\sum }_{i = 1}^{T} {\sum }_{j = 1}^{N} {\tilde{p}}_{ij} {n}_{ij} / S ] - {p}_{1 , s - 1} ) , & ( 1 ) \\ where & \\ S = {\sum }_{i = 1}^{T} {\sum }_{j = 1}^{N} {n}_{ij} , with {n}_{1 j} = 0 , j < s and {n}_{T , j} = 0 , j > e , & ( 2 )\end{matrix}$$

and \tilde{p}ᵢⱼ is the execution price in bin j on day i.

The actual trade start date 1≦T_{Start}≦T and trade start bin s_{Start} do not have to match with the order placement date, 1, and time, s, e.g.,
nₖⱼ=0 for k<T_{Start}; j=1, . . . , N and k=T_{Start}; j=1, . . . , s_{Start}−1 (3)

One distinction among existing pre-trade transaction cost models is how \tilde{p}ᵢⱼ is forecasted to include price impact and spread costs. In general, these two cost components are modeled separately and thus the cost formula can be subdivided into

$$Pre\_Cost ( S , {( {n}_{ij} )}_{i = 1 , … , T ; j = 1 , … , N} ) = Pre\_CostSpread ( {( {n}_{ij} )}_{i = 1 , … , T ; j = 1 , … , N} ) + Pre\_CostPI ( S , {( {n}_{ij} )}_{i = 1 , … , T ; j = 1 , … , N} ) \qquad ( 4 )$$

where Pre_CostSpread is the pre-trade transaction cost estimate due to the spread and Pre_CostPI is the pre-trade transaction cost estimate due to the price impact.

Typically, the price impact costs are decomposed into a temporary and a permanent component. The temporary price impact may be of a transitory nature and is purely an inventory effect where market imbalances are adjusted with price incentives. The permanent or persistent price impact reflects changes in the market participant's views about the value of the security due to one's trading. Thus, demanding liquidity with a BUY reveals to the market that the security may be undervalued, whereas demanding liquidity with a SELL signals that the security may be overvalued.

In order to forecast the expected price impact associated with S units of a particular security with a trading horizon of T days, mid quote prices at the end of each bin are often modeled iteratively. For example, the mid quote price pᵢⱼ at the end of bin j of day i associated with the executed trade volume nᵢⱼ may be modeled as a function of the previous bin's last mid quote price pᵢⱼ₋₁, the trade volume nᵢⱼ, the volume Vᵢⱼ, the volatility σᵢⱼ and the market sentiment msᵢⱼ, i.e.,
pᵢⱼ=f(Vᵢⱼ,σᵢⱼ,msᵢⱼ,nᵢⱼ,pᵢⱼ₋₁). (5)

Given that the actual trade volume, volatility, and market sentiment are not known prior to the trading, most of the pre-trade cost models optimize their trading strategies using historical intra-day mean or median volume and volatility. As for the market sentiment, it is either ignored or modeled as a function of past trade imbalances or returns. Consequently, the “true” equation (5), is approximated by the estimate
\hat{p}ᵢⱼ=f(E(Vᵢⱼ),E(σᵢⱼ),0,nᵢⱼ,\hat{p}ᵢⱼ₋₁). (6)

where E( ) denotes the expected value and may be estimated by the historical mean or median. Therefore, instead of estimating transaction costs based on the “true” price dynamics in equation (5) pre-trade models use equation (6).

Post-trade models have the benefit of the availability of actual execution data and can utilize all the trade information from the actual trading process. However, one cannot simply replace estimated variables in a pre-trade model (e.g., ex. (6)) with the true variables in (5) to arrive at a predictable, useful solution. Replacing estimated variables in a pre-trade model with actual data is problematic for at least three reasons. First, the above mentioned pre-trade models are structural models and require variable input that is relatively smooth and free of outliers. Unusual volume or volatility can cause unintuitive results. Second, using equation (5) does not solve the problem of possible model misspecification. That is, if the model is wrong, better input variables will not necessarily result better cost estimates. Third, all of the input variables such as intra-day volume, volatility, and trade imbalances are affected by one's own trading. However, a post-trade model is supposed to be a benchmark and not “gameable.” In addition, an econometric problem of endogeneity arises, which is discussed in more detail below.

According to embodiments of the present invention, after deriving expected transaction costs from a pre-trade model, general market effects from the time when the trades actually took place are incorporated into the post-trade model. This model, according to embodiments of the present invention, may incorporate factors such as market returns and trade imbalances. This, post-trade cost model can thus be given by the equation

$$Post\_Cost ( S , {( {n}_{ij} )}_{i = 1 , … , T ; j = 1 , … , N} ) = Pre\_Cost ( S , {( {n}_{ij} )}_{i = 1 , … , T ; j = 1 , … , N} ) + {γ}_{1} \cdot {X}_{1} ( S , T ) + … + {γ}_{N} \cdot {X}_{N} ( S , T ) , \qquad ( 7 )$$

where S is the order size, T is the trading horizon (in days) and Xⱼ(S,T) are factors such as the normalized actual volume over the trading period (V(T)−E(V(T)))/E(V(T)),

the normalized actual volatility over the trading period (σ(T)−E(σ(T)))/E(σ(T)),

the normalized actual spread over the trading period (s(T)−E(s(T)))/E(s(T)), and

a proxy of the signed intra-day stock-specific momentum over the trading period m((nᵢⱼ),T)/E(σ(T)).

The coefficients γ₁, γ₂, . . . , γ_{N} can be estimated for different exchanges and liquidity groups using the following Panel data regression:

$$Realized\_Cost ( S , {( {n}_{ij} )}_{i = 1 , … , T ; j = 1 , … , N} ) - Pre\_Cost ( S , {( {n}_{ij} )}_{i = 1 , … , T ; j = 1 , … , N} ) = {γ}_{1} \cdot {X}_{1} ( S , T ) + {γ}_{N} \cdot {X}_{N} ( S , T ) + ɛ . \qquad ( 8 )$$

Equation (7) assumes that there is no bias in the pre-trade model, i.e., Average (left hand side of Equation (7))=Average (right hand side of Equation (7)). If the equality does not hold, a multiplicative calibration factor C can be added in front of “Pre_Cost” in the equation. Thus, the equation would be:

$$Post\_Cost ( S , {( {n}_{ij} )}_{i = 1 , … , T ; j = 1 , … , N} ) = C * Pre\_Cost ( S , {( {n}_{ij} )}_{i = 1 , … , T ; j = 1 , … , N} ) + {γ}_{1} \cdot {X}_{1} ( S , T ) + … + {γ}_{N} \cdot {X}_{N} ( S , T ) .$$

In what follows we assume C=1.

Further, stock-specific intra-day momentum is not used directly because the stock-specific momentum proxy and transaction costs are highly correlated and co-dependent. Ignoring endogeneity between costs and the stock-specific momentum proxy may lead to biased estimates. Thus, it may be possible to obtain large R²'s when regressing costs against the stock-specific momentum proxy because both variables are co-dependent. However, the associated regression parameters may be misleading since the distance function would not be able to obtain stable parameter estimates.

To avoid endogeneity, the stock-specific momentum proxy within the trading period T may be approximated with an instrumental variable that is determined by factors completely independent of the selected pre-trade model. Specifically, for the most liquid stocks, stock-specific momentum proxy may be estimated with the intra-day market return and the stock-specific trade imbalances during the trading period. For liquid stocks, the sector return and trade imbalances can be used, and for the least liquid stocks, the sector return, the industry return, and trade imbalances can be used. The use of the various returns is preferred since very liquid stocks will tend to drive the industry return and thus, introduce an endogeneity problem that embodiments of the present invention address.

Trade imbalances may be defined as the intra-day signed share volume imbalances. The trades are classified as BUYS and SELLS using a generalized version of the Lee and Ready (1991) algorithm. Trades above (below) the mid quote are classified as BUYS (SELLS). Trades at the mid quote are classified using the tick test, i.e., up ticks are classified BUYS and down ticks are classified SELLS.

The stock-specific intra-day momentum may be defined as the strategy-weighted return starting at the order decision time and ending when the order is fully executed. Specifically, for the stock-specific intra-day momentum

$$\begin{matrix} m ( ( {n}_{ij} , T ) ) = {\sum }_{i = 1}^{T} {\sum }_{j = 1}^{N} \frac{{n}_{ij}}{S} \cdot ( {p}_{ij} - {p}_{1 s - 1} ) / {p}_{1 s - 1} , \\ if {T}_{Start} = 1 and {s}_{Start} = s , & ( 9 ) \\ and & \\ m ( ( {n}_{ij} ) , T ) = \underbrace{( {\sum }_{i = {T}_{Start}}^{ T} {\sum }_{j = 1}^{ N} \frac{ {n}_{ij}}{ S} \frac{( {p}_{ij} - {p}_{1 {s}_{Start} - 1} )}{ {p}_{1 s - 1}} )}_{(* )} + ( \frac{ {p}_{1 {s}_{Start} - 1} - {p}_{1 s - 1}}{ {p}_{1 s - 1}} ) . & ( 10 )\end{matrix}$$

Equation (10) incorporates the stock-specific momentum proxy between order placement time (1,s) and the time when the order starts to be executed at (T_{Start},s_{Start}). The endogeneity problem occurs only when trading starts. Consequently, the stock-specific intra-day momentum component (*) may be the only part that needs to be approximated by an instrumental variable.

The intra-day market, sector, and industry momentums may be defined and calculated the same way as in (*) of equation (10), i.e., as the strategy-weighted returns from (T_{Start}, s_{Start}) to (T,e). The stock-specific trade imbalance may be defined similarly using intra-day trade imbalances instead of returns in (*) of equation (10).

The strategy (nᵢⱼ) found in (9) and (10) and therefore in the post-trade estimate defined in (7), can be either a pre-trade strategy (e.g. an optimal strategy based on a certain risk aversion parameter), or an actual trading strategy. These two strategies measure two different things: choosing the pre-trade strategy evaluates actual realized costs versus the cost of continuing with the pre-trade strategy. Choosing the realized strategy evaluates an execution against peers that used the same trading strategy. With both options, inclusion of the strategy in the momentum calculations adds more strategy-dependence in the post-trade cost estimates of the present invention.

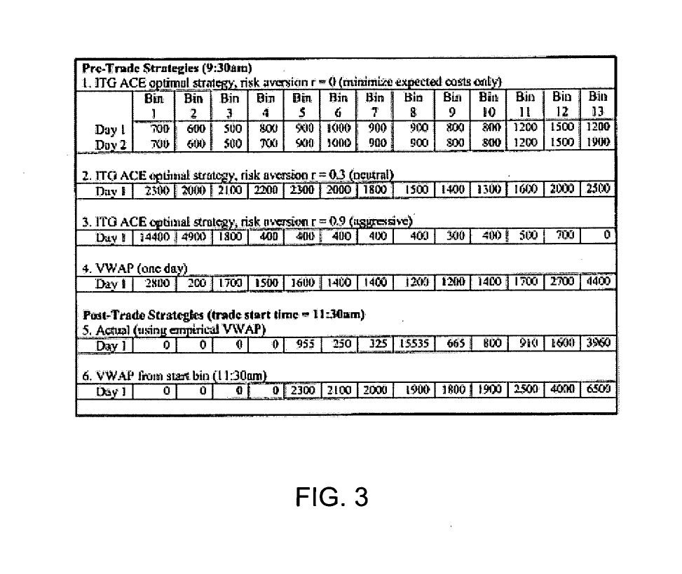

FIG. 3 is a table reporting results in order to illustrate various trading strategies. For a hypothetical order in Argonaut Inc. (Symbol AGII) of 25,000 shares which is approximately 18% of median daily share volume (MDV), report four different pre-trade strategies are reported. The pre-trade strategies are based on the information set at the time of order placement, here 9:10 am on Aug. 1, 2006.

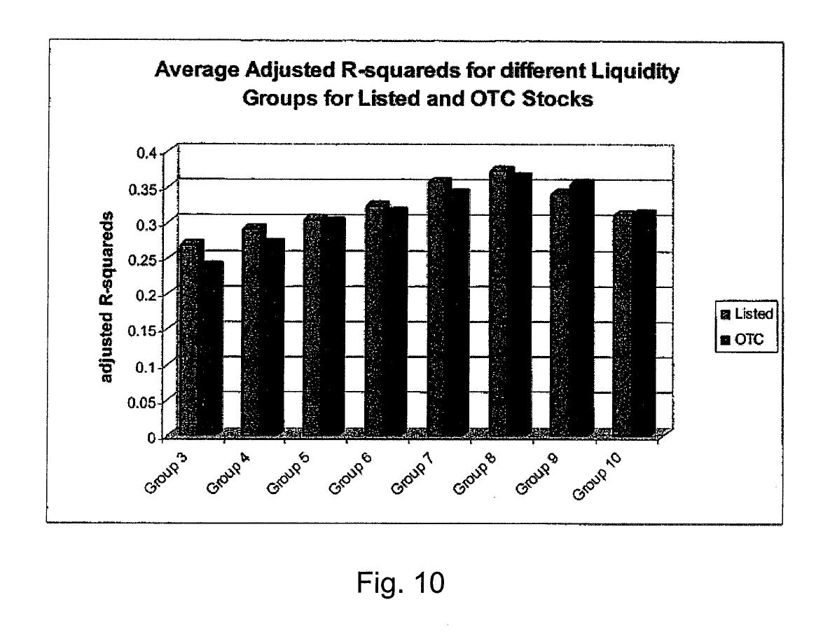

The first strategy assumes zero risk aversion, that is, ignore risk associated with a trading strategy is ignored and the expected transaction costs are minimized. In the example, ITG® ACE® gives a two-day strategy as optimal strategy. The shares in each trading bin are reported in FIG. 10.

The second strategy assumes a risk aversion of 0.3, which is considered as being neutral. Now, ITG® ACE®'s optimal strategy is a one-day strategy that is somewhat front-loaded.

The third strategy assumes a risk aversion of 0.9, which is considered as being aggressive. ITG® ACE®'s optimal strategy is a one-day strategy with heavy trading early in the day. Finally, the fourth pre-trade strategy is a one-day Volume-Weighted Average Price (VWAP) strategy. The strategy mirrors the average intra-day volume distribution of the stock.

These pre-trade strategies are optimal at the time of order entry at 9:30 am. However, traders usually adjust their trading behavior during the course of the day to current market conditions. For our example, trading for the order actually does not start until 11:30 am.

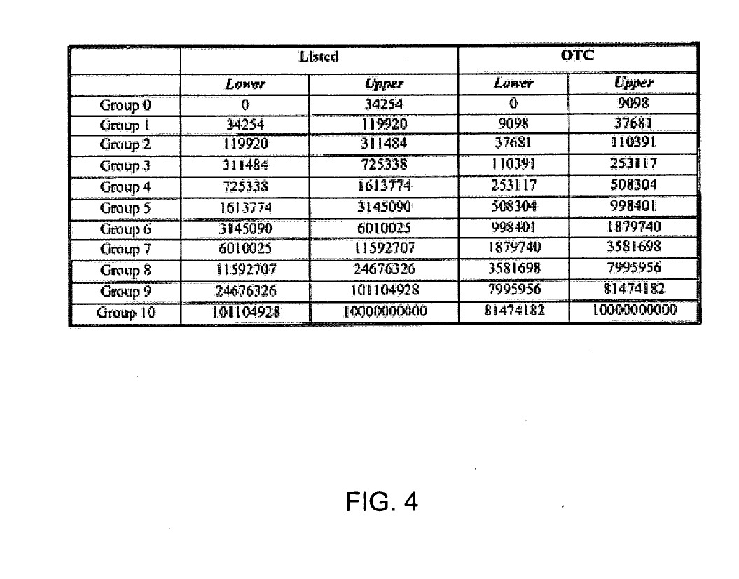

FIG. 3 reports two such strategies that utilize all available information. Strategy 5 is based on the actual empirical VWAP on that day. A trader just trades with the order flow of the stock. Finally, Strategy 6 is based on a VWAP strategy put in place at 11:30 am when trading starts. That means one may trade according to the volume distribution estimated at 11:30 am. It is obvious from FIG. 4 that different strategies yield quite different trading patterns. These trading patterns enter equations (9), (10), and thus also (7) through the strategy (nᵢⱼ).

Data

This section describes the data that have been used to estimate post-trade agency costs. To model post-trade costs, data from ITG's proprietary Peer Group Database™ (PGD), which consists of execution data (market and limit orders) from more than 80 large investment management firms. (Systems and methods for generating the PGD data are disclosed and claimed in U.S. patent application Ser. No. 10/674,432, filed on Oct. 1, 2003, the entire contents of which are incorporated herein by reference.)

The following examples are based on U.S. execution data collected from April 2004 to March 2006. The data are collected from seventy-four institutions. To minimize transaction costs, investment managers break large orders into multiple smaller orders. The cost associated with the fragmented elements of the initial intended trade may then be reported in the database. In order to capture the price impact and execution costs of institutional trading associated with the initial order, a clustering technique is introduced which is well known in the transaction cost literature (see e.g., Chan and Lakonishok (1995)). A BUY (SELL) “cluster” is the successive purchases (sales) of a particular stock by the same manager. The order cluster ends when the manager stays out of the market for at least one day, the manager does not execute more than 2% of median daily volume (MDV), there are no other trades that have been placed as an order within the execution horizon of the package.

After reconstructing the initial clusters, the market conditions associated with each cluster may be identified. Generally, the execution time stamps are not reported. In order to establish a trading timeline, it may be assumed that the investment manager used a volume-weighted average price (VWAP) trading strategy. Large institutions often use VWAP as their benchmark. Using ITG's Agency Cost Estimator (ITG® ACE®), one can derive the pre-trade cost estimates of each cluster which may be based on historical market conditions and neutral market sentiment. Consequently, the pre-trade ITG® ACE® costs are entirely based on one's own trading strategy and direct market impact. Pre-trade ITG® ACE® per se does not assume market effects due to other market participants. It may be assumed that a VWAP trading strategy with trading horizon in days. This strategy reflects the benchmark costs for an average (typical) trader during the trading horizon.

Listed and OTC stocks may be distinguished to take into account cost differences for different market structures. Listed stocks may be listed on the New York Stock Exchange (NYSE) or the American Stock Exchange (Amex) or other suitable exchange. All other stocks may be considered OTC stocks. Stocks may then be grouped based on their 21-day median dollar volume. Up to all available stocks (approximately 7,000) may be ranked according to their 21-day median dollar volume at the beginning of each month during the sample period. For Listed and OTC stocks separately, the stocks may be divided into eleven liquidity groups. Liquidity group 0 represents the least liquid stocks and liquidity group 10 represents the most liquid stocks. The table in FIG. 4 presents the liquidity group thresholds for Listed and for OTC stocks, respectively.

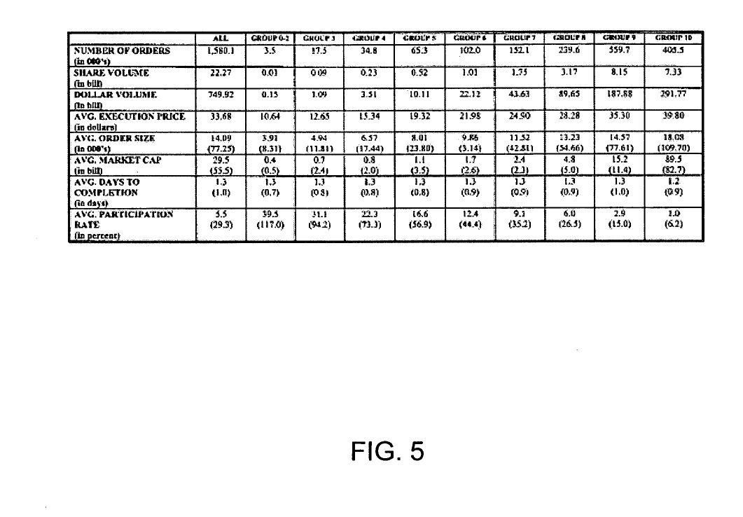

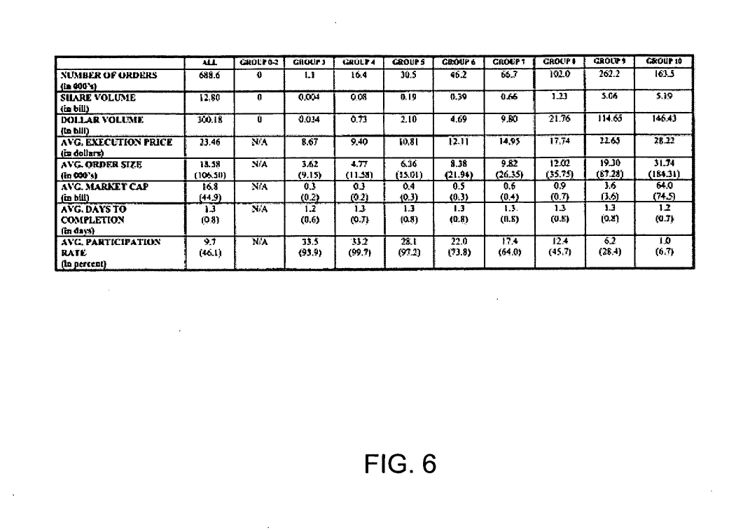

FIG. 5 is a table that reports descriptive statistics for Listed stocks, and FIG. 6 is a similar table for OTC stocks. For Listed stocks, FIG. 5 reports almost 1.6 million orders in the sample with more of the orders being concentrated in the more liquid stocks. Share volume ranges from a low of 10 million shares for liquidity groups 0-2 to 8.15 billion shares for liquidity group 9 with the total share volume of executed orders being 22.27 billion. Dollar volume totals almost $750 billion dollars and ranges from $150 million for liquidity groups 0-2 to almost $292 billion for liquidity group 10. The average execution price across all orders is $33.68, but the average execution price raises from $10.64 for the least liquid stocks to $39.80 for the most liquid stocks. The average order size is about 14,000 shares with a range from 3,910 to more than 18,000 shares. The most liquid stocks have the largest average order size and the standard deviation also is largest for the most liquid stocks. The average market capitalization is $29.5 billion. For liquidity groups 0 through 8 the firm size is relatively small between $400 million and $4.8 billion. Only for the liquidity groups 9 and 10 is the market capitalization substantial at $15.2 billion and $89.5 billion, respectively. The average days-to-completion is about 1.3 days for all liquidity groups. The time horizon of orders does not seem to depend on the liquidity groups. Overall, the average order executes 5.5% of median daily volume (MDV), as measured by the 21-day median. The participation rate ranges from 39.5% for the least liquid stocks to only 1% for the most liquid stocks. Obviously, for less liquid stocks, any order constitutes a substantial amount of daily trading volume.

For OTC stocks, the table in FIG. 6 reports almost 690 million orders in our sample with more of the orders being concentrated in the more liquid stocks. For liquidity groups 0-2, there are no observations at all. Share volume ranges from a low of 4 million shares for liquidity group 3 to 5.19 billion shares for liquidity group 10 with the total share volume of executed orders being 12.80 billion. Dollar volume totals over $300 billion dollars and ranges from $34 million for liquidity group 3 to over $146 billion for liquidity group 10. Compared to the Listed stocks in FIG. 5, there are fewer observations and less trading activity for OTC stocks. The average execution price across all orders is $23.46, but the average execution price raises from $8.67 for the least liquid stocks to $28.22 for the most liquid stocks. The OTC stocks in our sample tend to be lower-priced stocks compared to the Listed stocks. The average order size is about 18,600 shares with a range from 3,620 to almost 32,000 shares. The most liquid stocks have the largest average order size and the standard deviation also is largest for the most liquid stocks. Compared to the Listed stocks, orders in the OTC stocks tend to be larger. The average market capitalization is $16.8 billion. For liquidity groups 3 through 9 the firm size is relatively small between $300 million and $3.6 billion. Only for the liquidity group 10 is the market capitalization substantial at $64 billion. As expected, the OTC stocks are smaller compared to the Listed stocks in our sample. The average days to completion is about 1.3 days for all liquidity groups. The time horizon of orders does not seem to depend on the liquidity groups. This finding is identical to the Listed stocks. Overall, the average order executes 9.7% of median daily volume (MDV), as measured by the 21-day median. The participation rate ranges from 33.5% for the least liquid stocks to only 1% for the most liquid stocks. The average participation rate may be greater for the OTC stocks since the OTC stocks are less liquid compared to the Listed stocks.

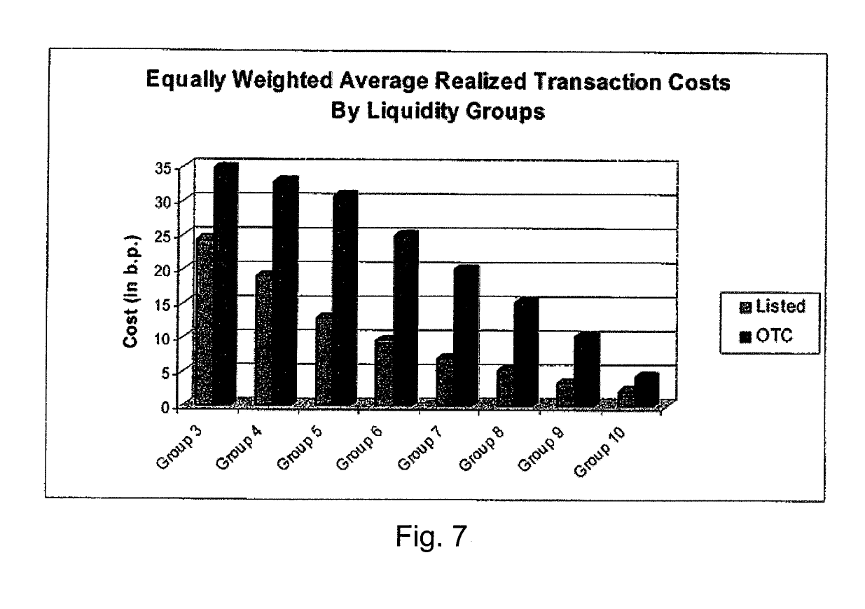

FIG. 7 graphs the average realized transaction costs for all liquidity groups. Average costs are decreasing as the liquidity of a stock increases for both Listed and OTC stocks. They range from almost 25 basis points (bps) to about 2 bps for Listed stocks and from almost 35 bps to about 4 bps for OTC stocks. The pattern in transaction costs may be attributed mostly to the fact that less liquid stocks have larger bid-ask spreads. Note that average costs for Listed and OTC stocks may not be directly comparable because of different liquidity group thresholds.

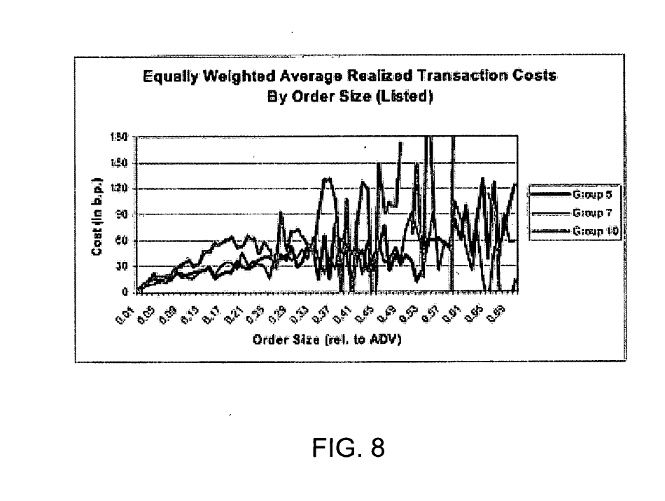

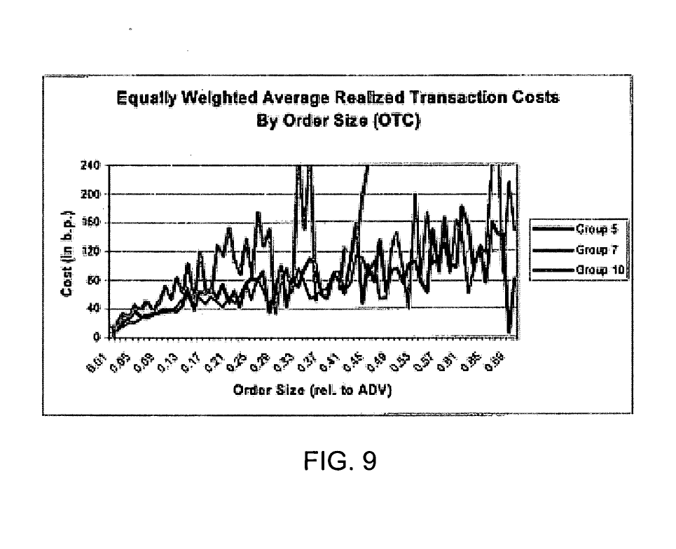

FIGS. 8 and 9 display average realized costs by relative order size (relative to MDV) for different liquidity groups of listed and OTC stocks, respectively. The charts show that average costs increase in relative order size due to price impact. Most liquid stocks, liquidity group 10, have higher realized costs due to higher price impact. However, for lower liquidity groups, there seems to be little difference in average realized costs between groups. One should also keep in mind that the same relative order sizes for liquidity group 10 and liquidity group 5 mean a very different actual order size. This may explain the higher price impact costs for the most liquid stocks. OTC stocks appear to be more expensive than Listed stocks when controlling for order size only.

For each liquidity group and for Listed and OTC, the parameters in equation (8) may be estimated separately. In the following, consider the one-factor model

$$Post\_Cost ( S , {( {n}_{ ij} )}_{i = 1 , … , T ; j = 1 , … , N} ) - Pre\_Cost ( S , {( {n}_{ ij} )}_{i = 1 , … , T ; j = 1 , … , N} ) = γ \cdot {m}_{proxy} ( ( {n}_{ij} ) , T ) + ɛ , \qquad ( 11 )$$

where m_{proxy} is the signed proxy for stock-specific intra-day momentum.

The dependent and independent variables are normalized with the stock-specific volatility to control for heteroskedasticity. This one factor model is motivated in part by its mere simplicity. Modeling the impact associated with deviation from expected volume and volatility may only be significant during unusual and unexpected stock-specific events. The proxies for stock-specific intra-day momentum have been estimated based on a 60-day rolling window. Note that it may be independent of one's own trading since only market, sector or industry movements and trade imbalances are factored in net of one's own trading.

Equation (11) and the discussion above show that the approach described has decomposed transaction costs into two components: the costs due to one's own trading and the costs due to general market effects.

Empirical Results

Empirical evidence associated with how market dynamics variables affect the prediction of transaction costs are described next.

When empirically modeling equation (11), there may be two potential problems. The first problem relates to the concern of endogeneity where the stock-specific momentum proxy is correlated with the error term. To alleviate this problem the share-weighted market, the share-weighted sector, and the share-weighted industry return along with the stock-specific trade imbalances excluding one's own trading are used as instrumental variables as described above.

Note that for the time between order decision and actual start of trading, the stock-specific intra-day momentum could be used without introducing endogeneity as in equation (10). Consequently, the results would only improve by using the stock-specific momentum proxy in equation (10).

The second problem relates to the fact that the model coefficients for the difference in pre- and post-trade costs may depend on liquidity group (defined in FIG. 4), Listed vs. OTC, and order size. A non-parametric approach may be used to address this issue. The parameter coefficients are estimated separately for different order size buckets (relative to MDV). Order size buckets are 0-1%, 1-2%, . . . , 99-100% of MDV. The coefficient estimates for the size buckets may then be smoothed with a polynomial function.

The performance of the instrumental variables may be assessed by analyzing the prediction errors between the stock-specific momentum proxy and the instrumental variable prediction. For liquidity group 10, the prediction error is within 50 bps for the majority of cases with extremes of as much as 120 bps. This compares to the stock-specific momentum proxy of as much as about 210 bps. For liquidity group 3, a large portion of the distribution of the prediction error is again within 50 bps. However, in the extreme, the prediction error is as large as about 200 bps which compares to the stock-specific momentum proxy of more than 350 bps. Overall, these results indicate that the instrumental variable approach in post-trade ACE explains a considerable amount of the stock-specific momentum proxy.

FIG. 10 reports average adjusted R²,s for regression (11) over all order sizes for different liquidity groups for Listed and OTC stocks. The R²'s are slightly lower for OTC stocks than for Listed stocks. They are greatest for liquidity groups 8 at about 38% and 37%, and lowest for liquidity groups 3 at about 27% and 24% for Listed and OTC stocks, respectively. R²s for liquidity groups 0, 1, and 2 are not reported since there are not enough observations (see FIGS. 5 and 6). Overall, the R²s are of considerable magnitude.

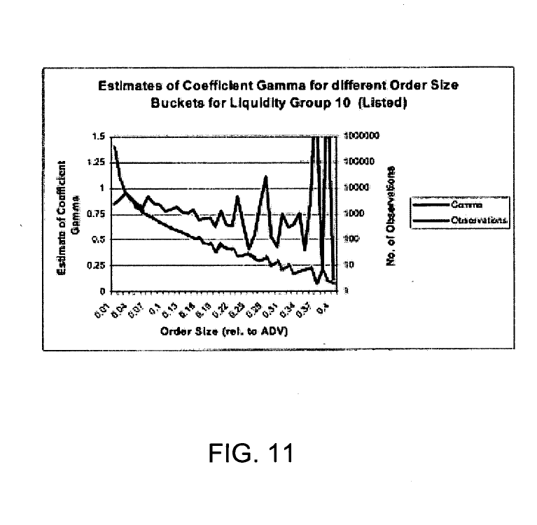

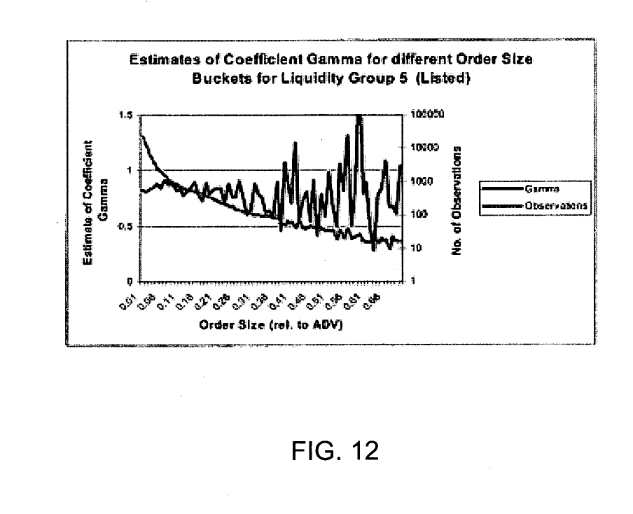

FIGS. 11 and 12 show the estimates of coefficient γ in regression (11) for different order size buckets for selected liquidity groups of the Listed stocks. Results are qualitatively the same for other liquidity groups and OTC stocks. The two graphs indicate that γ is decreasing with relative order size. This result is intuitive. For larger order sizes, the permanent price impact due to one's own trading should become more and more important. The coefficient estimates exhibit larger fluctuations with increasing order size. This may be due to the dramatically lower number of observations for larger order sizes.

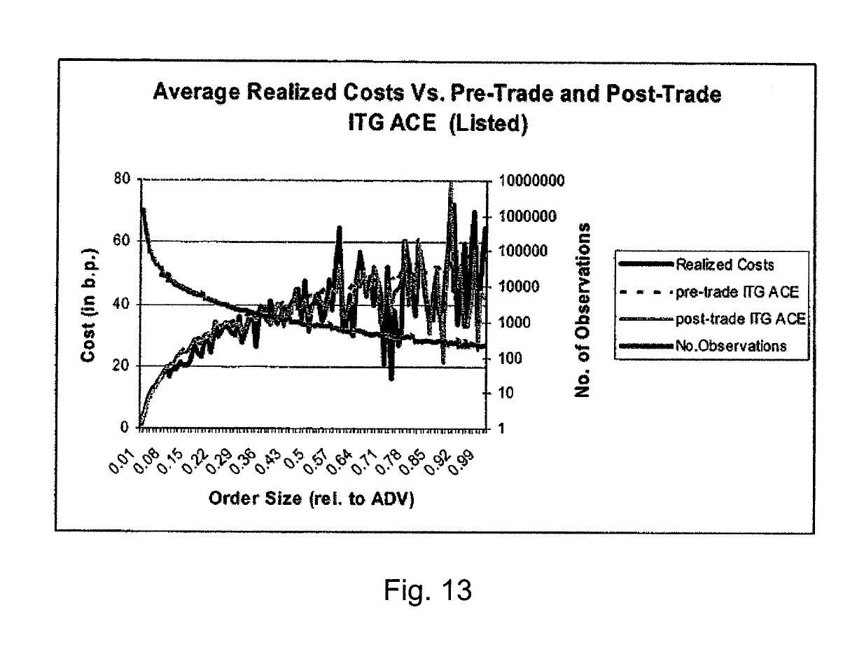

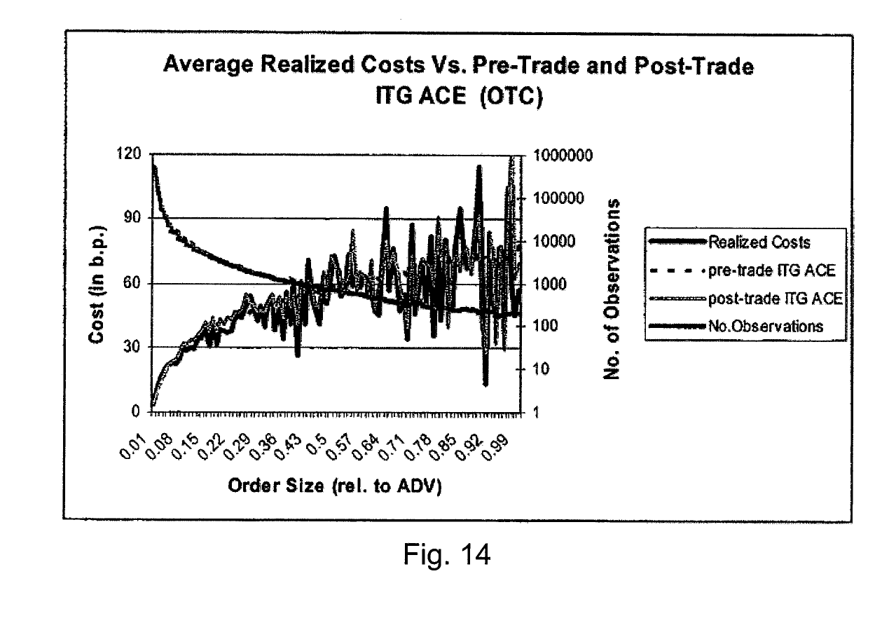

FIGS. 13 and 14 plot average realized transaction costs, pre-trade ITG® ACE®, and post-trade ITG® ACE® transaction cost estimates for Listed and OTC stocks, respectively. In both charts realized and pre-trade ITG® ACE® transaction costs match very well. This is no surprise since pre-trade ITG® ACE® transaction cost estimates are calibrated to realized transaction costs. However, the pre-trade ITG® ACE® estimate may be much smoother than the average realized costs. This is to be expected since a smooth estimator may be constructed that does not take into account market conditions. The post-trade ITG® ACE® transaction cost estimates are also very similar to the realized costs. Compared to the pre-trade ITG® ACE® estimates, they are more volatile and closer to the realized costs. Again, this is to be expected, since for post-trade ITG®ACE®, market conditions are taken into account and average realized costs are better explained.

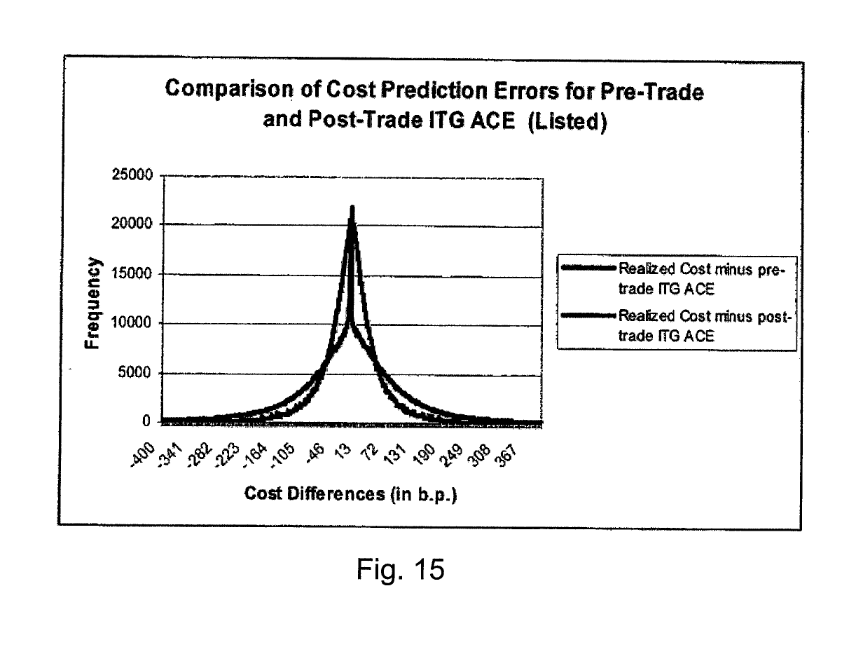

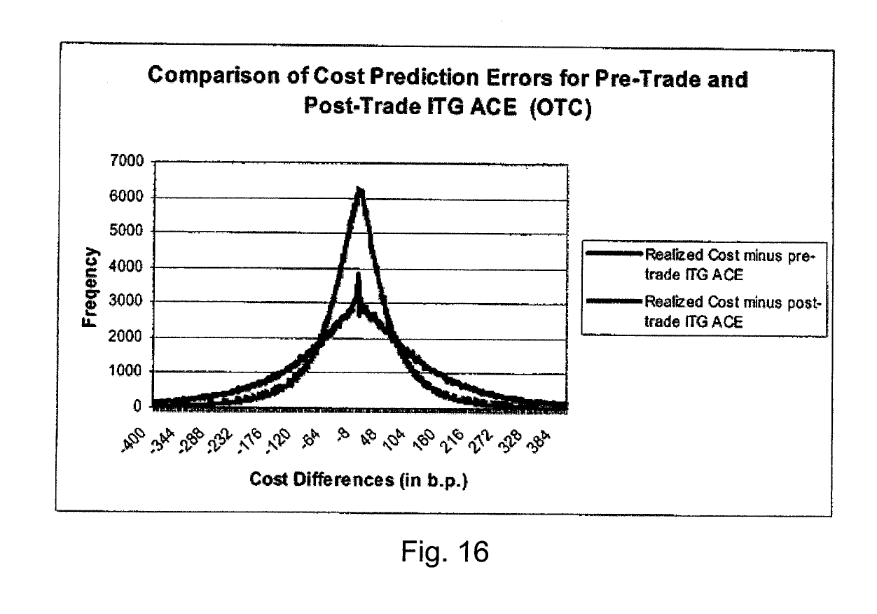

FIGS. 15 and 16 plot the distributions of the prediction errors of pre-trade and post-trade ITG® ACES transaction cost estimates for Listed and OTC stocks, respectively. Both charts show that the prediction error of pre-trade ITG® ACE® is much more fat-tailed. The post-trade ITG® ACE® estimates fit the realized costs better.

This rather intuitive and simple model for reconciling pre-trade transaction cost with that of post-trade may not account for opportunistic traders who only trade when market conditions are favorable. The realized costs for opportunistic traders may not match with the costs of traders who have to execute. As a result, there are two pre-trade ITG® ACE® cost estimates: one is called pre-trade discretionary ITG® ACE® and the other is called pre-trade non-discretionary ITG® ACE®. As the names indicate, for pre-trade discretionary ITG® ACE®, all executions are included, i.e., even orders for which the traders can postpone or abandon trading to take advantage of the market conditions. For pre-trade non-discretionary ITG® ACE®, opportunistic executions may be excluded and only include orders for which the traders do not have much discretion and have to execute the orders no matter if the market is favorable or not.

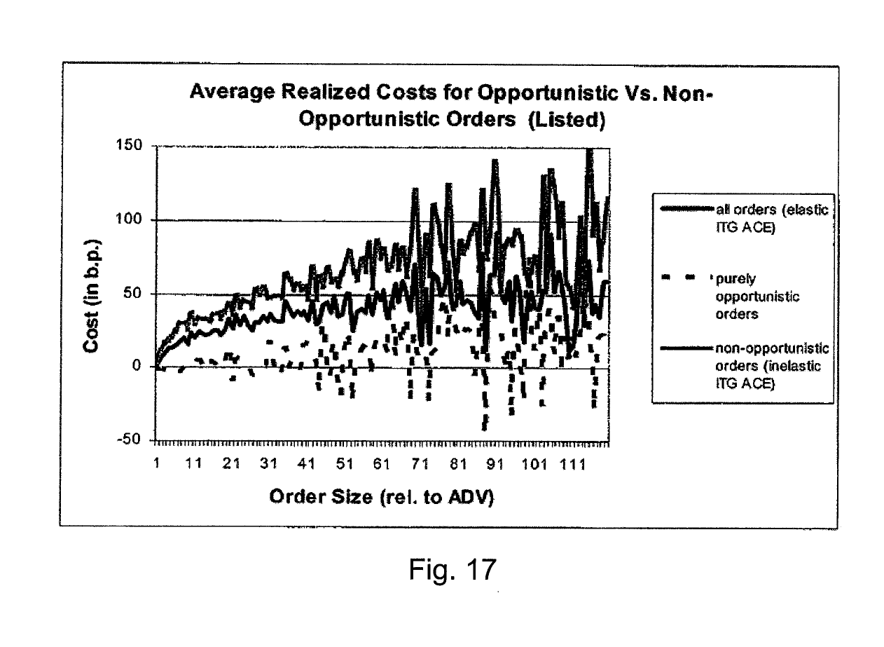

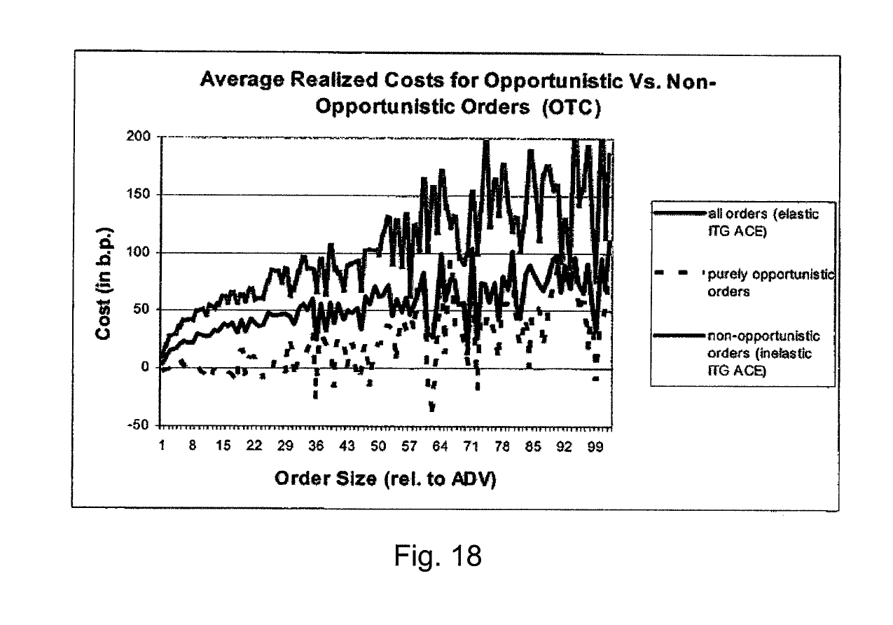

FIG. 17 and FIG. 18 plot the average realized costs curves that are associated with pre-trade discretionary and non-discretionary ITG® ACE® along with the average realized cost curve for opportunistic orders for Listed and OTC stocks, respectively. In both charts it is apparent that opportunistic orders are very different, they have very low costs, often close to zero and costs do not increase with order size. The cost curve associated with pre-trade non-discretionary ITG® ACE® is above the cost curve associated to pre-trade discretionary ITG® ACE®, as expected. Excluding the opportunistic orders pushes the cost curve up. As discussed above, the difference in the curves is bigger the larger the order size is.

It will be understood that the present invention will provide beneficial results with respect to aggregated trades and may not provide accurate results for a single trade evaluated alone. Thus, aggregation of trades allows for meaningful analyses and comparisons.

Additionally, it should be noted that the post-trade models of the present invention are especially useful because they can be accurate with a significantly small dataset. This is illustrated in FIGS. 15 and 16, where the curve representing the realized cost minus post-trade ITG® ACE® achieves minimal cost difference at a lower frequency than the curve representing the realized cost minus post-trade ITG® ACE®.

One or more aspects of the present invention may includes a computer-based product, which may be hosted on a storage medium and include executable for performing one or more steps of the invention. Such storage mediums can include, but are not limited to, computer disks including floppy or optical disks or diskettes, CDROMs, magneto-optical disk, ROMs, RAMs, EPROMs, EEPROMs, flash memory, magnetic or optical cards, or any type of media suitable for storing electronic instructions, either locally or remotely.

In another embodiment of the current invention, the post-trade model can be used to provide systems and methods for simulating trades. For example, a trader could run a series of simulations using the post-trade model of the current invention, and compare the average cost of his/her trades using various trading strategies, such as VWAP. This is especially useful given that the post-trade analysis of the current invention accounts for intra-day market conditions, such as: normalized trading volume, normalized trading volatility, normalized actual spread, and the stock-specific momentum proxy. By simulating the intra-day conditions that the market is currently experiencing or is likely to experience in the future, a trader utilizing a post trade simulator of the current invention would be able to run a series of simulations iteratively to arrive at an optimal trading strategy for the intra-day market conditions. These simulations may rely on the use of historical data in creating a simulated market against which various trading strategies may be tested. These iterations can be conducted manually or automatically, and during each iteration one or more variables of the simulation may be changed. The variables can include but are not limited to, the trading strategy of the trader, and the market conditions in which the simulation is to be run. For example, if the market is trending towards higher volatility for large cap stocks, a series of simulations could be run that not only changed the trading strategies being used, but also increased the volatility of the simulated market. Once the simulations have been run, a trader could consider the average trading costs and the distribution of trading costs for each strategy in the various market conditions, allowing the trader to make an educated decision as to how to proceed in the real market. One skilled in the art will understand that steps and computer components, programs, modules, and/or facilities can be added to systems and methods described above in order to provide such a novel simulation system or method.

In another embodiment of the present invention, the post-trade model can be applied to any other type of tradable assets, such as: futures, currencies or derivatives. Further, the present invention may be used in relation to one or more foreign markets, and is not limited to U.S. markets. Country specific variables may be added, and United States specific variables may be deleted, in order to utilize the post-trade methods and systems of the current invention. Moreover, the present invention may be used to analyze transaction costs in models that span countries.

The invention being thus described, it will be apparent to those skilled in the art that the same may be varied in many ways without departing from the spirit and scope of the invention. In particular, the invention is not limited to the specific examples and embodiments described herein. For example, additional factors may be added or subtracted from the models of the present invention. Any and all such modifications are intended to be included within the scope of the following claims.

1. A method for estimating transaction costs, comprising:
for a plurality of proposed trade orders associated with a trading entity, calculating estimated pre-trade transaction costs for each of the proposed trade orders based on a selected trade strategy and on historical market data;
receiving execution data relating to a plurality of executed trades corresponding to said proposed trade orders;
calculating estimated post-trade transaction costs for each said executed trade based upon corresponding cost of said estimated pre-trade transaction costs and on corresponding execution data of said execution data; and
aggregating estimated post-trade transaction costs to generate an aggregated estimated post-trade transaction cost for said trading entity.

2. The method as claimed in claim 1, where said calculating estimated post-trade transaction costs step is based upon market returns and trade imbalances relating to said proposed trade orders.

3. The method as claimed in claim 1, wherein said calculating estimated post-trade transaction costs step includes execution of the equation:
$$Post\_Cost ( S , {( {n}_{ij} )}_{i = 1 , … , T ; j = 1 , … , N} ) = Pre\_Cost ( S , {( {n}_{ij} )}_{i = 1 , … , T ; j = 1 , … , N} ) + {γ}_{1} \cdot {X}_{1} ( S , T ) + … + {γ}_{N} \cdot {X}_{N} ( S , T )$$
where S is an order size, T is a trading horizon (in days) and Xⱼ(S,T) are trade factors over a trading period (V(T)−E(V(T)))/E(V(T)),
a normalized actual volatility over the trading period (σ(T)−E(σ(T)))/E(σ(T)),
a normalized actual spread over the trading period (s(T)−E(s(T)))/E(s(T)), intra-day volatility,
and
a proxy of a signed intra-day stock-specific momentum over the trading period m((nᵢⱼ),T)/E(σ(T)).

4. The method as claimed in claim 3, where γ₁, γ₂, . . . , γ_{N} are coefficients estimated for different exchanges and liquidity groups using a data regression:
$$Realized\_Cost ( S , {( {n}_{ij} )}_{i = 1 , … , T ; j = 1 , … , N} ) - Pre\_Cost ( S , {( {n}_{ij} )}_{i = 1 , … , T ; j = 1 , … , N} ) = {γ}_{1} \cdot {X}_{1} ( S , T ) + … + {γ}_{N} \cdot {X}_{N} ( S , T ) + ɛ .$$

5. The method as claimed in claim 1, wherein a trading horizon is divided into a number of bins, and each said step is performed in at least one bin, and said calculating estimated post-trade transaction costs step incorporates a normalized actual volume during the bin; a normalized actual volatility during the bin; a normalized actual spread during the bin; and a stock-specific momentum proxy during the bin.

6. The method as claimed in claim 5, wherein the stock-specific momentum proxy is determined using intra-day market return and stock specific trade imbalances during the bin; sector return and trade imbalances during the bin; or sector return, industry return, and trade imbalances.

7. The method as claimed in claim 6, wherein which data is used in determining the stock-specific momentum proxy is based on a liquidity measure of a specific stock.

8. A computer program product comprising a computer storable medium storing computer executable instructions for estimating transaction costs, said computer executable instruction performing operations comprising:
for a plurality of proposed trade orders associated with a trading entity, calculating estimated pre-trade transaction costs for each of the proposed trade orders based on a selected trade strategy and on historical market data;
receiving execution data relating to a plurality of executed trades corresponding to said proposed trade orders;
calculating estimated post-trade transaction costs for each said executed trade based upon corresponding cost of said estimated pre-trade transaction costs and on corresponding execution data of said execution data; and
aggregating estimated post-trade transaction costs to generate an aggregated estimated post-trade transaction cost for said trading entity.

9. The computer program product as claimed in claim 8, where said calculating estimated post-trade transaction costs operation is based upon market returns and trade imbalances relating to said proposed trade orders.

10. The computer program product as claimed in claim 8, wherein said calculating estimated post-trade transaction costs operation includes execution of the equation:
$$Post\_Cost ( S , {( {n}_{ij} )}_{i = 1 , … , T ; j = 1 , … , N} ) = Pre\_Cost ( S , {( {n}_{ij} )}_{i = 1 , … , T ; j = 1 , … , N} ) + {γ}_{1} \cdot {X}_{1} ( S , T ) + … + {γ}_{N} \cdot {X}_{N} ( S , T )$$
where S is an order size, T is a trading horizon (in days) and Xⱼ(S,T) are trade factors over a trading period (V(T)−E(V(T)))/E(V(T)),
a normalized actual volatility over the trading period (σ(T)−E(σ(T)))/E(σ(T)),
a normalized actual spread over the trading period (s(T)−E(s(T)))/E(s(T)), intra-day volatility,
and
a proxy of a signed intra-day stock-specific momentum over the trading period m((nᵢⱼ),T)/E(σ(T)).

11. The computer program product as claimed in claim 10, wherein γ₁, γ₂, . . . , γ_{N} are coefficients estimated for different exchanges and liquidity groups using a data regression:
$$Realized\_Cost ( S , {( {n}_{ij} )}_{i = 1 , … , T ; j = 1 , … , N} ) - Pre\_Cost ( S , {( {n}_{ij} )}_{i = 1 , … , Tj = 1 , … , N} ) = {γ}_{1} \cdot {X}_{1} ( S , T ) + … + {γ}_{N} \cdot {X}_{N} ( S , T ) + ɛ$$

12. The computer program product as claimed in claim 8, wherein a trading horizon is divided into a number of bins, and each said step is performed in at least one bin, and said calculating estimated post-trade transaction costs step incorporates a normalized actual volume during the at least one bin; a normalized actual volatility during the at least one bin; a normalized actual spread during the at least one bin; and a stock-specific momentum proxy during the at least one bin.

13. The computer program product as claimed in claim 12, wherein the stock-specific momentum proxy is determined using intra-day market return and stock specific trade imbalances during the at least one bin; sector return and trade imbalances during the at least one bin; or sector return, industry return, and trade imbalances.

14. A system for market simulation utilizing post-trade estimation of transaction costs, comprising:
transaction cost estimation facilities configured to receive order data relating to a plurality of trade orders, receive simulated execution data relating to a plurality of simulated trades corresponding to said plurality of trade orders, to calculate post trade estimated transaction costs for each of said plurality of trade orders based upon a pre-trade cost estimation model, said execution data, and simulated market conditions at an execution time of said plurality of trades, and to store said post trade estimated transaction costs;
a market simulator for simulating said market conditions utilizing historical trade data and generating simulate market data; and
data storage facilities coupled with said transaction cost estimation facilities and configured to store at least said post trade estimated transaction costs in an accessible format.

15. The system as claimed in claim 14, wherein
said transaction cost estimation facilities are configured to calculate estimated post-trade transaction costs further based upon market returns and trade imbalances relating to said proposed trade orders;
said calculating estimated post-trade transaction costs operation includes execution of the equation:
$$Post\_Cost ( S , {( {n}_{ij} )}_{i = 1 , … , T ; j = 1 , … , N} ) = Pre\_Cost ( S , {( {n}_{ij} )}_{i = 1 , … , T ; j = 1 , … , N} ) + {γ}_{1} \cdot {X}_{1} ( S , T ) + … + {γ}_{N} \cdot {X}_{N} ( S , T )$$
where S is an order size, T is a trading horizon (in days) and Xⱼ(S,T) are trade factors over a trading period (V(T)−E(V(T)))/E(V(T)),
a normalized actual volatility over the trading period (σ(T)−E(σ(T)))/E(σ(T)),
a normalized actual spread over the trading period (s(T)−E(s(T)))/E(s(T)), intra-day volatility, a proxy of a signed intra-day stock-specific momentum over the trading period m((nᵢⱼ),T)/E(σ(T)), and
where γ₁, γ₂, . . . , γ_{N} are coefficients estimated for different exchanges and liquidity groups using a data regression:
$$Realized\_Cost ( S , {( {n}_{ij} )}_{i = 1 , … , T ; j = 1 , … , N} ) - Pre\_Cost ( S , {( {n}_{ij} )}_{i = 1 , … , T ; j = 1 , … , N} ) = {γ}_{1} \cdot {X}_{1} ( S , T ) + … + {γ}_{N} \cdot {X}_{N} ( S , T ) + ɛ ;$$
a trading horizon is divided into a number of bins, and each said step is performed in at least one bin, and said calculating estimated post-trade transaction costs step incorporates a normalized actual volume during the bin, a normalized actual volatility during the bin, a normalized actual spread during the bin, and a stock-specific momentum proxy during the bin; and
said stock-specific momentum proxy is determined using either the intra-day market return and stock specific trade imbalances during the bin, sector return and trade imbalances during the bin, or sector return, industry return, and trade imbalances, based on a liquidity measure of a specific stock.

16. A system for post-trade estimation of transaction costs, comprising:
transaction cost estimation facilities configured to receive order data relating to a plurality of trade orders, receive execution data relating to a plurality of trades corresponding to said plurality of trade orders, to calculate post trade estimated transaction costs for each of said plurality of trade orders based upon a pre-trade cost estimation model, said execution data, and actual market conditions at an execution time of said plurality of trades, and to store said post trade estimated transaction costs; and
data storage facilities coupled with said transaction cost estimation facilities and configured to store at least said post trade estimated transaction costs in an accessible format.

17. The system as claimed in claim 16, where said transaction cost estimation facilities are configured to calculate estimated post-trade transaction costs further based upon market returns and trade imbalances relating to said proposed trade orders.

18. The system as claimed in claim 16, wherein said calculating estimated post-trade transaction costs operation includes execution of the equation:
$$Post\_Cost ( S , {( {n}_{ij} )}_{i = 1 , … , T ; j = 1 , … , N} ) = Pre\_Cost ( S , {( {n}_{ij} )}_{i = 1 , … T ; j = 1 , … , N} ) + {γ}_{1} \cdot {X}_{1} ( S , T ) + … + {γ}_{N} \cdot {X}_{N} ( S , T )$$
where S is an order size, T is a trading horizon (in days) and Xⱼ(S,T) are trade factors over a trading period (V(T)−E(V(T)))/E(V(T)),
a normalized actual volatility over the trading period (σ(T)−E(σ(T)))/E(σ(T)),
a normalized actual spread over the trading period (s(T)-E(s(T)))/E(s(T)), intra-day volatility, and
a proxy of a signed intra-day stock-specific momentum over the trading period m((nᵢⱼ),T)/E(σ(T)).

19. The system as claimed in claim 18, wherein γ₁, γ₂, . . . , γ_{N} are coefficients estimated for different exchanges and liquidity groups using a data regression:
$$Realized\_Cost ( S , {( {n}_{ij} )}_{i = 1 , … , T ; j = 1 , … , N} ) - Pre\_Cost ( S , {( {n}_{ij} )}_{i = 1 , … , T ; j = 1 , … , N} ) = {γ}_{1} \cdot {X}_{1} ( S , T ) + … + {γ}_{N} \cdot {X}_{N} ( S , T ) + ɛ$$

20. The system as claimed in claim 16, wherein a trading horizon is divided into a number of bins, and each said step is performed in at least one bin, and said calculating estimated post-trade transaction costs step incorporates a normalized actual volume during the bin; a normalized actual volatility during the bin; a normalized actual spread during the bin; and a stock-specific momentum proxy during the bin.

21. The system as claimed in claim 20, wherein the stock-specific momentum proxy is determined using intra-day market return and stock specific trade imbalances during the bin; sector return and trade imbalances during the bin; or sector return, industry return, and trade imbalances.

22. The system as claimed in claim 21, wherein which data is used to in determining the stock-specific momentum proxy is based on a liquidity measure of a specific stock.

23. A system for post-trade estimation of transaction costs, comprising:
transaction cost estimation means for receiving order data relating to a plurality of trade orders, execution data relating to a plurality of trades corresponding to said plurality of trade orders, and generating post trade estimated transaction costs for each of said plurality of trade orders based upon a pre-trade cost estimation model, said execution data, and actual market conditions at an execution time of said plurality of trades; and
data storage means for storing at least said post trade estimated transaction costs in an accessible format.

24. The system as claimed in claim 23, wherein said transaction cost estimation means further comprises:
pre-trade modeling means for generating pre-trade estimated transaction costs for said plurality of trade orders based upon said pre-trade cost estimation model; and
post-trade modeling means for generating post-trade estimated transaction costs for said plurality of trade orders based upon said pre-trade cost estimation transaction costs, said execution data, and actual market conditions at an execution time of said plurality of trade orders.

25. The system as claimed in claim 23, further comprising display means for displaying said post trade estimated transaction costs to a user of the system.
